(19) United States
(12) Patent Application Publication
(10) Pub. No.: US 2012/0133136 A1
(43) Pub. Date: May 31, 2012

(54) ADJUSTABLE WIND-RESISTANCE WINDMILL WITH INDICIA

(75) Inventor: George J. Igel, V, Reynoldsburg, OH (US)

(73) Assignee: WINDMARKET, LLC, Reynoldsburg, OH (US)

(21) Appl. No.: 13/306,449

(22) Filed: Nov. 29, 2011

Related U.S. Application Data
(60) Provisional application No. 61/417,499, filed on Nov. 29, 2010.

(51) Int. Cl. H02P 9/04; B64C 27/54

(52) U.S. Cl. 290/44; 416/98

(57) ABSTRACT

A windmill having a substantially vertical tower to which a rotatable hub is mounted. At least three arms extend substantially horizontally from the hub and terminate in cones having louvers that can be opened and closed, such as by a servo motor and linkage. A computer receives a signal from a wind direction sensor and actuates the opening and closing of the louvers to optimize wind resistance depending upon the orientation of the cone relative to the wind direction. Indicia are preferably placed on one or both sides of the louvers.

### CROSS-REFERENCES TO RELATED APPLICATIONS

This application claims the benefit of U.S. Provisional Application No. 61/417,499 filed Nov. 29, 2010. This prior application is hereby incorporated by reference.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

The invention relates generally to energy production apparatuses, and more particularly to a cost-effective windmill, the construction costs of which can be subsidized by selling advertising and/or marketing space on windmill blades in prime high traffic zones along major highways.

Windmills are well known electromechanical devices for converting mechanical wind energy into electrical energy using a rotary generator mechanically linked to the driven windmill blades. Common windmill blades rotate around a horizontal axis in the manner of an airplane propeller. Such windmills are efficient but costly to construct and maintain.

Anemometers are rotary, wind-driven devices that rotate about a vertical axis. Anemometers use “cones” at the ends of arms mounted to a hub to catch wind and rotate in one direction, thereby measuring wind speed. Anemometers rotate in one direction because the cones are all oriented to cause wind to flow over the closed end with little resistance, and wind to flow over the open end with substantial resistance. This generates a net torque in one direction that results in rotation.

It would be advantageous to create a windmill to generate electricity using some of the features of an anemometer.

### BRIEF SUMMARY OF THE INVENTION

The invention is an aerodynamic, large scale wind speed anemometer that is preferably fabricated at a location that is remote from the final site of the installed windmill. The windmill is then assembled on-site quickly in a small “footprint” with minimal construction equipment, such as a crane, needed. The site of installation for the windmill is preferably a high-traffic area, such as adjacent highways and at intersections. This location maximizes the visibility of the windmill, because in a preferred embodiment marketing space on the windmill arms and cones is leased, for example for advertising or other indicia. The design preferably has the aerodynamic properties of an anemometer to allow for a billboard-sized and shaped cone for marketing presentation.

In a preferred embodiment, three or more cones are each mounted to the same number of aerodynamic arms to a hub that is mounted on the top of a tower. The tower is preferably strongly mounted in the earth or to another advantageously-fixed structure such as buildings and bridges. The hub is supported by low resistance bearing supports that transfer the weight of the cones, arms and hub to the tower. A drive shaft extends from the hub down the center of the tower to the transmission, if desired, and electric generator placed in or near the base of the tower. The placement of the transmission and generator at ground level provides at least three advantages. First, maintenance can be performed on the transmission and the generator without expense for cranes or bucket lifts. Second, installation and assembly costs are kept low without the need for a large crane to lift the generator to the top of the tower. Third, the cost of the tower will remain low because its design does not have to include support for the additional weight of a generator at the top. The only known disadvantage is a minimal loss of energy through the turning resistance of a long drive shaft and mounts.

In many regards, the windmill is similar in overall construction to a conventional wind anemometer mounted atop a cell phone tower. Thus, the windmill anemometer is a large scale version in which each of the three or four (or more) cones that catch the wind are actively operated to increase and decrease wind resistance depending on their rotary position. In prior art anemometers the cones catch the wind more in one direction than the other, and always remain the same configuration. In the invention the cones of the present invention are mechanically modified to optimize wind resistance even more.

The preferred cones are generally rectangular in shape, but many other shapes will become apparent to the person having ordinary skill from the description herein. The preferred cones have multiple rows of moveable louvers that open and close to decrease and increase, respectively, wind resistance. The louvers are preferably parallel to the arm connecting the cone to the center hub, and the louvers, when closed, form a panel that collects and significantly resists passage of the prevailing wind through the cone. The louvers can be opened, such as by a servo motor or another prime mover, in order to dramatically reduce the wind resistance of the opened cone. In a preferred embodiment, when each cone's front end moves into the wind, that cone's louvers are opened to minimize the wind resistance on the cone. Similarly, when each cone's back end moves into the wind the louvers of that cone are closed to maximize the wind resistance on the cone. The direction of the wind is sensed by a conventional wind vane or similar apparatus, and this wind direction information is processed by a programmable computer to open and close the louvers to optimize efficiency of the windmill. In a most preferred embodiment, at least some of the construction and operation costs of the windmill are provided by revenue gained from selling or leasing space on the louvers for advertising or other indicia.

### BRIEF DESCRIPTION OF THE SEVERAL VIEWS OF THE DRAWINGS

FIG. 1 is a schematic side view in section illustrating the preferred embodiment of the present invention.

FIG. 2 is a top view illustrating the embodiment of FIG. 1.

FIG. 3 is a top view illustrating the embodiment of FIG. 1 in an initial position relative to the wind direction W_{d}.

FIG. 4 is a top view illustrating the embodiment of FIG. 1 in a second, slightly advanced position relative to the initial position of FIG. 3.

FIG. 5 is a top view illustrating the embodiment of FIG. 1 in a third, further advanced position relative to the position of FIG. 4.

FIG. 6 is a top view illustrating the embodiment of FIG. 1 in a fourth, further advanced position relative to the position of FIG. 5.

FIG. 7 is a front view illustrating an arm and cone of the present invention.

FIG. 8 is a front view illustrating an arm and cone of the present invention showing indicia placed thereon.

FIG. 9 is a front view illustrating an arm and cone of the present invention showing the louvers completely open.

FIG. 10 is a front view illustrating an arm and cone of the present invention showing half of the louvers open and half of the louvers closed.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

Patent application Ser. No. 61/417,499 filed Nov. 29, 2010, which is the above-claimed priority application, is incorporated in this application by reference.

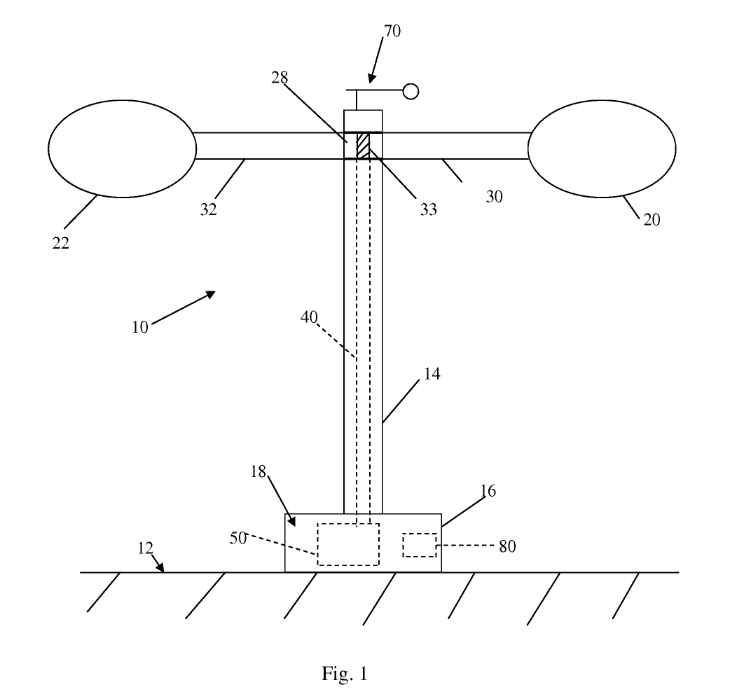

The preferred windmill 10 is shown in FIG. 1 mounted to a support 12, which includes the Earth, any structure firmly mounted to the Earth or any structure of sufficient mass to prevent movement of the entire windmill 10 relative to the Earth during operation of the windmill 10. For example, the support 12 can be a tower, a bridge or a building used for other purposes but still stable and strong. Alternatively, the support 12 can be a concrete platform anchored in the Earth.

The windmill 10 has a tower 14 that is preferably vertically oriented, but can be at any orientation that is sufficient or advantageous for the circumstances. The tower 14 is a tubular structure having a central barrel that permits the passage of a drive shaft 40 as will be described below. A base 16 that has an internal chamber 18 for a conventional generator 50 and other components can be incorporated into the tower 14 as shown and as described in more detail below.

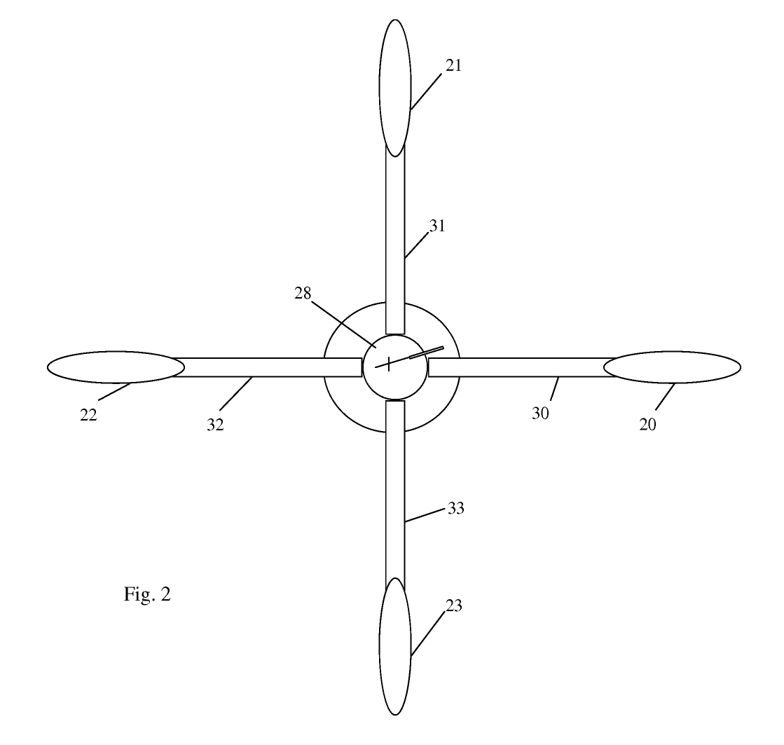

As shown in FIGS. 1 and 2, four cones 20, 21, 22 and 23 are mounted at or near the top of the tower 14 to the four arms 30, 31, 32 and 33. It will become apparent that any number of cones including three or more can be mounted to an equal number of arms, and this number is merely limited by cost and engineering concerns that will be apparent to the person having ordinary skill in the art. The arms 30-33 mount rigidly at their outer ends to the inner edges of the cones 20-23, respectively, and mount rigidly at the inner ends to the hub 28. The arms and hub are preferably made of steel, aluminum, fiber-reinforced composite or any other suitable material. The hub 28 is rotatably mounted at or near the top of the tower 14. In a preferred embodiment, the hub 28 is disposed as a collar near the top of the tower 14, as shown in FIG. 1, and the arms 30-33 mount at 90 degree intervals around the hub 28.

The drive shaft 40 mounts rigidly to the hub 28 and extends downwardly from the hub 28 to the generator 50 disposed in the base 16. A transmission (not shown) can be interposed between the driveshaft and the generator. Upon rotation of the hub 28 about the vertical axis, as driven by wind striking the cones 20-23, the driveshaft 40 is similar rotatably driven. This rotation of the driveshaft 40 rotates the driveshaft (not shown) of the generator 50, thereby generating electricity in a conventional manner. The electricity generated can be stored in batteries (not shown) in the base 16 that are used to operate electrical components within the windmill 10, or connected to a utility line and sold to the utility service provider.

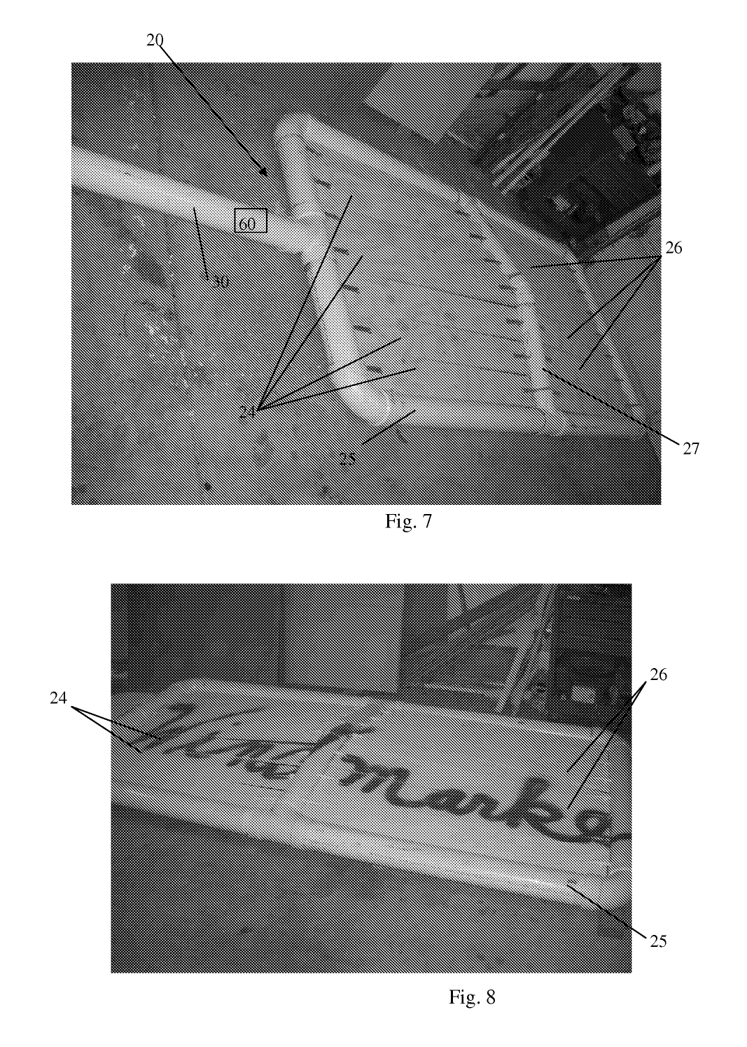

The cones 20-23 shown in FIGS. 1-2 are illustrated schematically having an oval shaped, but it will become apparent to a person having ordinary skill that the cones can be any other suitable shape. For example, the cones can be circular, rectangular as shown in FIG. 7, or irregularly shaped. The construction of the cones 20-23 and their opening and closing operation will now be described in more detail.

The cone 20 shown in FIG. 7 has a rigid frame 25 attached to the arm 30, and a plurality of louvers 24 and 26. It is preferred that the frame 25 be subdivided by a member 27 and that the outer set of louvers 26 be operable separate from the inner set of louvers 24. The cones 20-23 are mounted with the planes of their frames substantially perpendicular to a horizontal plane, whereby air moving in a direction parallel to the ground will tend to move the cones around the hub, the pivot axle of which is essentially vertical (perpendicular to the ground).

In FIG. 8, the opposite, front side of the cone 20 is shown having indicia, such as written letters, on the louvers 24 and 26. The indicia can be letters, as shown, but can also include drawings, logos, photographs or any other kind of image that is desirably displayed. Furthermore, although the indicia are shown over the entire front side of the louvers 24 and 26, it is contemplated that the indicia can be individualized to a particular set of louvers or to an individual louver. The indicia can be in the form of individual lights that are lighted in groups to form indicia, and can be in the form of an electronic display that forms images using technology known for televisions and computer displays.

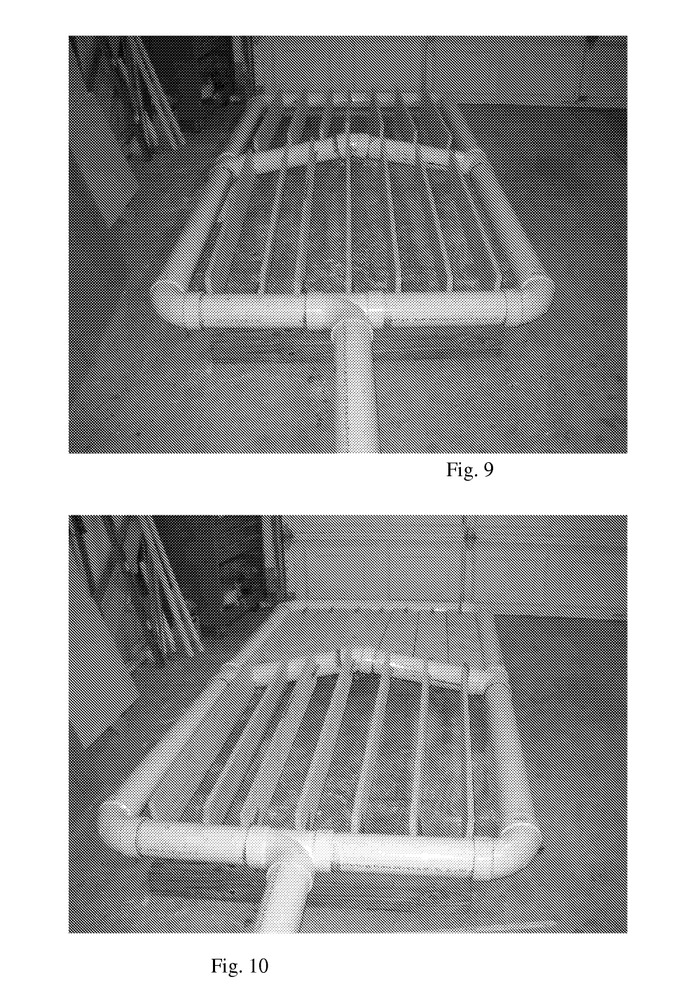

The louvers are preferably rotatably mounted to the frame 25 and the member 27 to rotate from a closed position shown in FIGS. 7 and 8 to an open position shown in FIG. 9, and preferably to any position in between. The louvers move about 90 degrees from the closed to the open position, and the movement is preferably driven by a prime mover, such as an electric servo motor 60 (shown in FIG. 7), a pneumatic ram or any equivalent apparatus. Likewise, a gearing system is contemplated that drives the louvers open and closed depending upon the prime mover, which is actuated according to the angle of the cone relative to the direction of the wind driving the cone. A mechanical linkage (not visible), in the manner of the linkage used to link the louvers of a conventional heating and cooling duct cover to a manually-displaceable tab, links the motor 60 to the louvers 24 and 26. This linkage thereby permits efficient displacement of the louvers between the open and the closed positions, and anywhere in between.

When the louvers are in the closed position, they provide the most resistance to air moving through the cone in a direction that is perpendicular to the plane of the louvers. When the louvers are in the open position, they provide the least resistance to air moving through the cone in a direction that is parallel to the plane of the louvers. Of course, when the louvers are open, the indicia are essentially invisible to anyone viewing the cones, and therefore it is contemplated that, under normal operating conditions, the louvers of at least one cone will always remain closed with the indicia visible. Further wind analysis might suggest that optimal torque and electrical energy production occurs when each individual louver can be selectively opened and closed apart from every other louver. In some embodiments at least some of the louvers are open while others are closed, as shown in FIG. 10, and the servo motor 60 and linkage are designed to permit selective opening and closing of louvers.

In a preferred embodiment, a wind vane 70 is mounted to the top of the tower 14 to be substantially driven by the wind to detect the direction of the wind in a conventional manner. The vane 70 sends a wind direction signal to a computer 80 in a conventional manner so that the computer 80 can use the signal to control the opening and closing of the louvers by the servo motor 60. It is also contemplated that other sensors can be mounted to or around the tower 14 to signal the computer 80, including at least sensors for hub 28 orientation relative to the tower 14, wind speed, temperature, relative humidity and barometric pressure. Therefore, when the wind direction and any other parameters are detected, this information is transmitted to the computer 80 in a conventional manner, such as by wires (not shown) or wirelessly. The computer 80 then uses programmed logic to control the servo motor 60, and every other servo motor connected to every other cone, to open and close the louvers at the optimal time.

As shown in FIG. 7, there is an inside row of louvers 24 and an outside row of louvers 26. The outside row is preferably angled relative to the inside row due to the V-shaped member 27 to form a “cup” shape in the cone 20 to better catch the wind from the rear and better slice through the wind from the front. The louvers 24 on one side of the V-shaped member 27 are at an angle relative to the louvers 26 on the opposite side of the V-shaped member 27. This angle can vary, but it is contemplated to vary from about 0 to about 25 degrees or whatever is the best aerodynamic angle. The “cup” shape allows the cone to hold the force of the prevailing winds through about 180 degrees of rotation around the hub 28, or some portion of the entire 360 degrees of rotation that best maximizes the energy transferred from the wind to the cones 20-23.

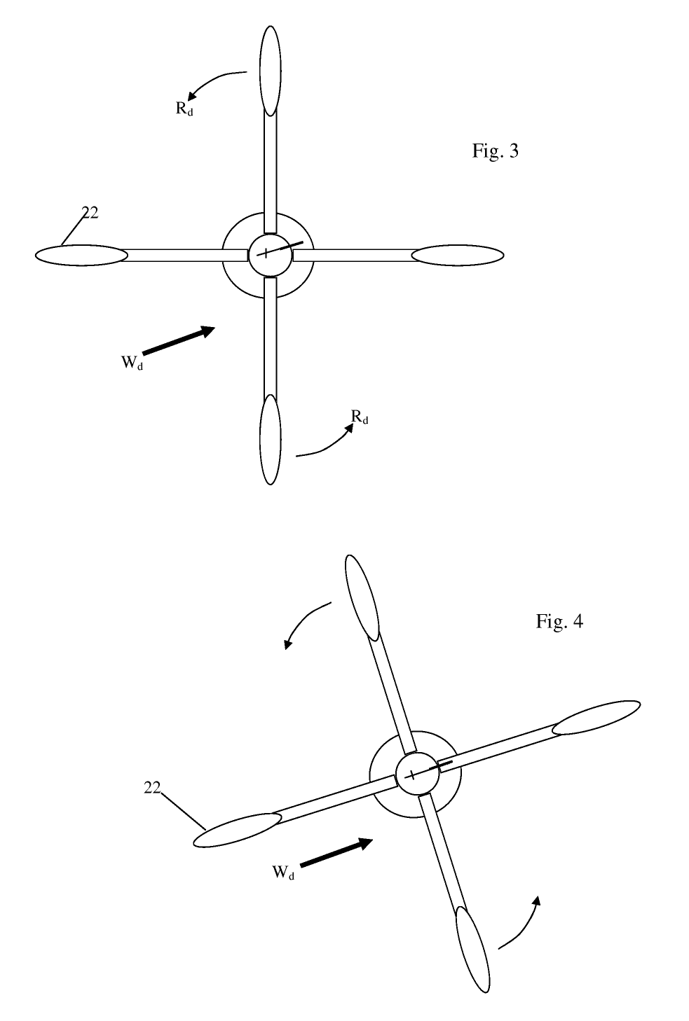

The computer 80 receives at least wind direction data, and, based on at least that data, the computer 80 calculates when each cone reaches the rotational limits for the wind to drive it, and when the wind resists each cone's continued rotation. As shown in FIGS. 3-6, the cones 20-23 are rotating around the tower 14 in the direction shown by the arrows Rd, and the wind is moving in the direction indicated by the arrow W_{d}. When the cone 22 is in the position shown in FIG. 3, the louvers are open, because the front of the cone 22 is being driven into the wind and minimal wind resistance is desired. However, as the plane of the cone 22 approaches or reaches an essentially “parallel” position relative to the wind direction, as shown in FIG. 4, the computer 80, using a pre-programmed algorithm that takes into account wind direction, cone location relative to wind direction and other factors, closes the louvers on the cone 22 to begin significantly resisting the passage of wind through the cone 22 from the rear by the time the cone reaches the orientation relative to the wind direction W_{d} shown in FIG. 5. The louvers are then closed until the cone 22 rotates about 180 degrees about the tower 14, in order to maximize wind resistance from the rear to gain the greatest force against the cone 22 during its movement around the hub. When the cone 22 has rotated about 180 degrees, the louvers are re-opened to minimize wind resistance when wind blows against the front during the next 180 degrees.

It should be understood that when the computer 80 triggers the servo motor 60 to rotate the louvers 24 and 26 ninety degrees to the open position, the resistance on the cone is minimized as the cone rotates the approximately 180 degrees with a component moving into the direction of the wind. Furthermore, when the computer 80 triggers the servo motor 60 to rotate the louvers 24 and 26 ninety degrees to the closed position, the resistance on the cone is maximized as the cone rotates the approximately 180 degrees with a component moving with the direction of the wind. Of course, if the wind direction shifts or other factors change, the louvers can be opened or closed at a different point of the rotation to maximize efficiency.

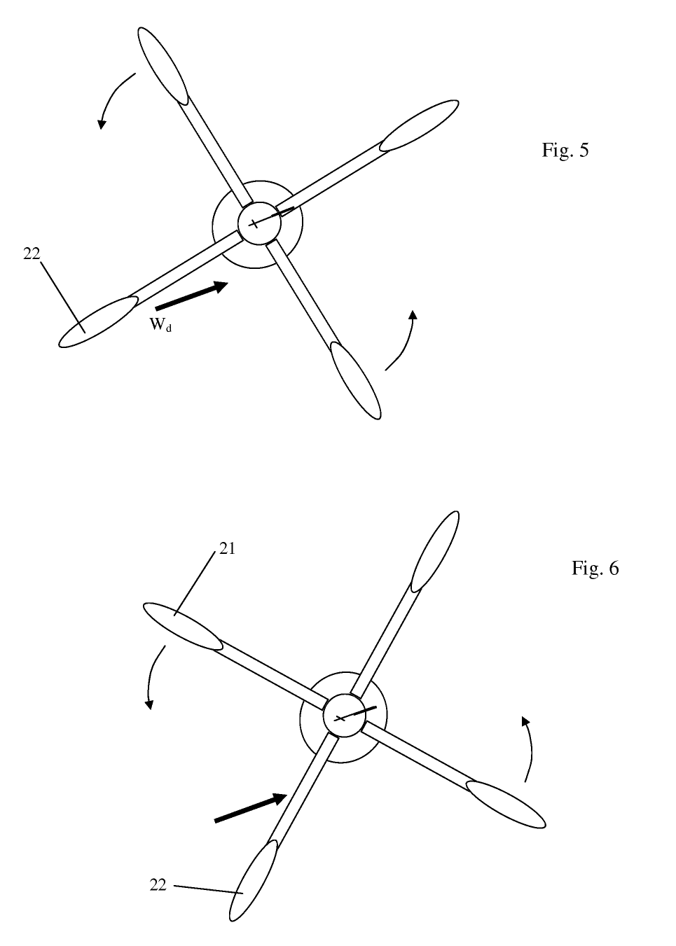

After the cone 22 is closed as shown in FIG. 6, the next cone 21 is changed from an open to a closed configuration in the same manner as the cone 22, and for essentially half of the rotation of the hub. Then the cone 21 is open for the second half of the hub's rotation. This opening and closing occurs in series to each of the cones 20-23 during the corresponding rotation of the cone around the tower 14 as will become apparent to the person having ordinary skill

Thus, based upon various factors understood by one having skill in the field of aerodynamics, windmills and related arts, the louvers that are closed to significantly resist air flowing through the cones from the rear to power the windmill 10 are subsequently opened to significantly reduce the amount of resistance to air flow against the cone from the front. This thereby reduces drag on the cone when rotating through the remaining 180 degrees of rotation of the cone where the wind does not have a power-increasing effect on the particular cone, but instead has a power-reducing effect. This sequence of opening and closing the louvers on the cones optimizes the ability of each cone to “catch” the force of the wind during the portion of that cone's rotation that the wind has the most energy-producing effect on the anemometer. During the remainder of the rotation, the cone's louvers are opened to reduce the energy-draining effect on the anemometer.

As shown in FIG. 8, indicia are painted, drawn, adhered or otherwise attached to one or both sides of the louvers 24 and 26. The indicia can include marketing words and/or images sold by the cone in long term leases. All louvers can remain closed to allow the advertising message to display during periods of little or no wind, and could be lit using LED technology at night for additional lease charges.

As the cones revolve around the tower 14, the louvers are open for about 180 degrees of rotation, providing visibility to the indicia as a “moving billboard” that will attract more attention than a stationary billboard if it is placed on the side of the road. Also different from a typical billboard, the indicia of the windmill 10 can be visible to traffic from all directions due to the orientation of the cones and their path of movement around a vertical axis. Because of this configuration, the closed louvers face different directions depending on the wind direction. This creates variations in the direction the indicia face during rotation, thereby increasing the exposure of the indicia to the surrounding area.

The design could also incorporate multiple uses of the tower. Placing the hub, arms and cones at the top of an extra tall tower would still allow placement of cell phone antennae partway down the tower 14. Because the power generator 50 is at the base 16 of the tower 14, there is minimal radio interference if the antenna wires are shielded when they reach the vicinity of the base beside the electric generator 50.

The tower 14 can support lights for roadways or interchange lighting. Mutual agreement to provide tower, lights and electricity for lighting highway or interchange could be packaged into a lease of public land at little or no cost. Access to prime advertising and marketing locations in the median on major highways at or near major intersections would benefit municipalities and advertisers, and would speed return on investment for a utility company while providing power with no greenhouse gases.

The foundation for the tower consists, in an embodiment contemplated, of four augured caissons (not visible), diameter and depth dependent on soil conditions, tower height, and expected wind load. Caissons are connected to columns above ground and extend approximately 10 feet above the proposed finish floor, forming support legs for a base plate of tower and support walls to protect the generator from outdoor elements. Panels attached to columns would have pedestrian access doors on two sides, and each panel hinges upward and outward (similar to garage door) to allow full access to the generator, transmission, and electric switchgear for maintenance. The tower is connected to beam framework bolted to the top of the caissons with a large hinge on one side. During construction the hinge can be used to tilt the tower into an upright position using a much smaller crane than would be necessary if trying to lift the tower and set it in place as one piece. The drive shaft is placed in the tower before tilting into the vertical position, and is affixed to the top and secured near the bottom for ready connections after the tower is vertical.

The hub is preferably built around the base of the tower, and the arms 30-33 and cones 20-23 are attached after the tower 14 is raised, for example while the assembly is about twelve feet above ground level. Two hoists inside the base 16, each with a cable going up the inside of the tower and over a sheave, are connected to the hub 28, and are used to raise the assembly of the hub 28, arms 30-33 and cones 20-23 into position at the top of the tower 14. Taglines are connected to one cone or one arm, and all louvers are in an open position to reduce wind force trying to rotate the assembly as the assembly is raised and connected at the top. The drive shaft is removed from its storage position and connected to the center of the hub with bolts by a worker on the inside of the tower who has climbed a maintenance ladder, and the hub is supported by a series of low resistance rollers (bolted to the inside of the hub after it is raised) that travel around a track on the outside of the tower at the top. This is attached by a worker in a bucket truck.

In an alternative embodiment, the top portion of the tower 14 includes a wind direction control box that is installed on the top of the hub 28 with a conical shield over the hub 28 and rollers to keep out inclement weather. The wind direction control box consists of a direction wind arm, such as the wind vane 70 with, for example, a round dial with a trigger on approximately 180 degrees of dial to make contact with a plurality of contact switches, one for each set of louvers composing a single cone. This control box is a basic logic circuit computer that controls the opening and closing of the louvers. Thus, as the hub 28 rotates, the position of each cone relative to the directional wind arm determines if the contactor triggers a solenoid to open the louvers in the cone for the travel upwind. A timer on each contactor switch allows all the louvers to close if there is no wind for a set period of time, providing visibility to the marketing on all three or more cones. The contactor switch and solenoid to control the louvers are powered by wiring to a power source, such as alternating current, using wires extending along the inside or outside of the tower 14 through a set of contactors under the hub. Alternatively, three deep cycle batteries power the contactor switch and solenoid, one battery for each cone, and these batteries are charged using a small windmill on the top of the tower. The power supply could also power light-emitting diode (LED) lights for nighttime illumination of the indicia.

The preferred linkage to open and close the louvers interconnects the louvers in an enclosed track using a gear on the end at the center post of each louver. The gears are connected together with bicycle chain, belt or similar looped transmission means. When the solenoid pulls an arm connected to the first gear, it thus turns each gear connected to a louver. The solenoid stays engaged until the hub has spun sufficiently to allow the contactor to signal the solenoid to release (i.e., the cone is in a position to catch the wind), or until the timer times out due to lack of hub rotation due to no wind. The louvers are spring-loaded or off-center mounted to close upon release so that current from the power source is only necessary to power the solenoid when wind is blowing.

The louvers, and preferably all other components of the windmill 10 exposed to the elements, are coated with a paint or other material to reduce the adhesion of snow, ice and any other matter to these structures in a manner that would prevent their proper operation. In appropriate geographic locations, heating elements can be incorporated into the louvers and other exposed components to remove any matter that might adhere despite paint or other coatings intended to reduce adhesion.

If desirable, the wind direction control box can include a computer that can be programmed to close all of the louvers if the hub is rotating too fast as a result of high winds, which should reduce the hub's speed due to the upwind resistance on the cone trying to travel against the wind. This will provide marketing visibility and a reduced wind generating capacity. Alternatively, if necessary, any combination of opening and closing of the louvers to reduce rotational speed to prevent excessive rotation is contemplated. Other combinations of opening and closing may become apparent from this description to a person having ordinary skill. As shown in FIG. 10, half or any fraction of the louvers can be closed while the other louvers are open, and vice versa, as will become apparent from the description herein.

It is contemplated that the transmission at the bottom of the drive shaft 40 connects to the power generator 50 to provide optimum torque and speed to maximize the electricity generated. This preferably has a variable ratio to allow a low gear for low wind startup, and as wind speed increases, a higher ratio for maximum electricity production. The transmission should also have a lockout that can be engaged to stop the shaft from rotation for maintenance work and when changes are made to the marketing message on the louvers.

Although the description above refers to “louvers”, it will become apparent to the person having ordinary skill that other structures that can be opened and closed to change the resistance to wind are equivalent to the louvers shown and described. For example, various vane and other openings are contemplated that provide similar or better structures to accomplish the purpose of rapid and efficient blocking and passage of the wind.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. An improved windmill having a tower, a hub rotatably mounted to the tower about a substantially vertical axis for rotating through a 360 degree path of rotation, a plurality of arms extending substantially horizontally from the hub and a plurality of cones, each cone mounted to a corresponding one of the arms, the improvement comprising:
(a) a plurality of louvers on each of the cones, the louvers movable between an open and a closed position;
(b) means for opening and closing the louvers;
(c) a wind direction sensor mounted near the windmill and producing a wind direction signal;
(d) a computer connected to the wind direction sensor and said means for opening and closing the louvers for receiving the wind direction signal from the wind direction sensor and actuating said means for opening and closing the louvers based upon the wind direction signal, thereby opening the louvers to decrease wind resistance during a portion of the rotation of the hub and to close the louvers to increase wind resistance during a different portion of the rotation of the hub.

2. The improved windmill in accordance with claim 1, further comprising indicia on the louvers.

3. The improved windmill in accordance with claim 1, further comprising:
(a) a generator drivingly linked to the hub;
(b) the generator connected to a power supply; and
(c) wherein said means for opening and closing the louvers is connected to the power supply.

4. The improved windmill in accordance with claim 3, wherein the power supply comprises at least one battery.

5. The improved windmill in accordance with claim 3, wherein the power supply comprises a conventional electric utility line.

6. A method of generating electricity using a windmill having a tower, a hub rotatably mounted to the tower about a substantially vertical axis for rotating through a 360 degree path of rotation, a plurality of arms extending substantially horizontally from the hub and a plurality of cones, each cone mounted to a corresponding one of the arms, the improvement comprising:
(a) closing a plurality of louvers on a first of the cones when wind strikes the first cone on a first side;
(b) opening the plurality of louvers on the first cone when wind strikes the first cone on a second side;
(c) closing a plurality of louvers on a second of the cones when wind strikes the second cone on a first side;
(d) opening the plurality of louvers on the second cone when wind strikes the second
(e) closing a plurality of louvers on a third of the cones when wind strikes the third cone on a first side;
(f) opening the plurality of louvers on the third cone when wind strikes the third cone on a first side;
(g) using a computer connected to a wind direction sensor mounted near the windmill to control the opening and closing of the louvers on the cones based upon a wind direction signal generated by the wind direction sensor, thereby opening the louvers to decrease wind resistance during a portion of the rotation of the hub and to close the louvers to increase wind resistance during a different portion of the rotation of the hub.
